(19) United States
(12) Patent Application Publication
(10) Pub. No.: US 2007/0194686 A1
(43) Pub. Date: Aug. 23, 2007

(54) Phosphor, phosphor paste composition including the same, and flat display device including phosphor layer including the phosphor

(76) Inventors: Seung-Uk Kwon, Suwon-si (KR); Young-Kwan Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,001

(22) Filed: Feb. 22, 2007

(30) Foreign Application Priority Data
Feb. 23, 2006 (KR) 10-2006-0017885

(51) Int. Cl. H01J 63/04; H01J 1/62

(52) U.S. Cl. 313/485; 313/582; 313/486

(57) ABSTRACT

A silicate-based blue phosphor coated with (or containing) metal oxide, a phosphor paste composition including the silicate-based blue phosphor coated with metal oxide, and a flat display device including a phosphor layer including the silicate-based blue phosphor coated with metal oxide are disclosed. In one embodiment, the silicate-based blue phosphor coated with metal oxide has a positive (+) surface charge and provides excellent discharge properties without a deterioration of brightness.

### CROSS-REFERENCE TO RELATED PATENT APPLICATIONS

This application claims the benefit of Korean Patent Application No. 10-2006-0017885, filed on Feb. 23, 2006, in the Korean Intellectual Property Office, the disclosure of which is incorporated herein in its entirety by reference.

### BACKGROUND OF THE INVENTION

1. Field of the Invention

The present invention relates to a phosphor, a phosphor paste composition including the phosphor, and a flat display device including a phosphor layer including the phosphor. More particularly, the invention relates to a silicate-based blue phosphor coated with metal oxide, a phosphor paste composition including the silicate-based blue phosphor coated with metal oxide, and a flat display device including a phosphor layer including the silicate-based blue phosphor coated with metal oxide. The silicate-based blue phosphor coated with metal oxide has a positive (+) surface charge so that it can provide excellent discharge properties without a deterioration of brightness.

2. Description of the Related Technology

Examples of display devices for conventional information communication media are personal computers and television sets. Display devices can be categorized into cathode ray tubes (CRTs) utilizing high-speed thermal electron emission and flat panel displays such as liquid crystal displays (LCDs), plasma display panels (PDPs), and electron emission displays.

In PDPs, discharges occur at the surfaces of a dielectric layer and a protective layer on an electrode by applying a voltage between transparent electrodes so that ultraviolet rays are generated, and the generated ultraviolet rays excite phosphor contained in a phosphor layer doped on a rear substrate, thereby emitting light. In electron emission displays, a strong electric field is provided to electron emission sources disposed at constant intervals on a cathode, thereby emitting electrons, and then the emitted electrons collide with the phosphor contained in a phosphor layer doped on an anode to thereby emit light.

The phosphor layer of the PDP can be prepared by applying a phosphor paste composition, which is prepared to have a predetermined viscosity, on a region on which the phosphor layer of the PDP is to be formed, and then heating the applied phosphor paste composition. A method of forming a phosphor layer using a phosphor paste composition is disclosed in, for example, Korean Patent Laid-open No. 2004-0003500.

Particularly, flat panel displays can realize full color images when their phosphor layers use red phosphor, green phosphor, and blue phosphor. The blue phosphor can be a BAM-based phosphor such as BaMgAl₁₀O₁₇:Eu²⁺ phosphor, a silicate-based blue phosphor such as CaMgSi₂O₆:Eu²⁺ phosphor, or the like.

Particularly, the silicate-based blue phosphor demonstrates a constant brightness even if used for a long time, but has a surface charge property of a ˜0 or negative (−) polarity. When the silicate-based blue phosphor is used together with a red phosphor and/or green phosphor that conventionally have a positive (+) surface charge, an undesirable miss discharge may occur.

### SUMMARY OF CERTAIN INVENTIVE ASPECTS

One aspect of the present invention provides a silicate-based blue phosphor coated with (or containing, hereinafter “coated with” for convenience) metal oxide, a phosphor paste composition including the silicate-based blue phosphor coated with metal oxide, and a flat display device including a phosphor layer including the silicate-based blue phosphor coated with metal oxide.

According to another aspect of the present invention, there is provided a silicate-based blue phosphor coated with metal oxide.

According to another aspect of the present invention, there is provided a phosphor paste composition that includes the silicate-based blue phosphor coated with metal oxide, a binder, and a solvent.

According to still another aspect of the present invention, there is provided a flat display device including a phosphor layer including the silicate-based blue phosphor coated with metal oxide.

The silicate-based blue phosphor coated with metal oxide has a positive (+) surface charge so that it can provide excellent charge properties without deterioration of brightness.

Another aspect of the invention provides a phosphor composition comprising a silicate-based phosphor and metal oxide. The silicate-based phosphor is a blue phosphor. The silicate-based blue phosphor has a positive electrostatic polarity. At least part of the silicate-based phosphor is in the form of particles, and wherein the metal oxide is formed on a surface of the phosphor particles. The metal oxide is in the form of particles, wherein the metal oxide particles have an average diameter in the range of about 10 nm to about 200 nm. The metal oxide is coated on at least some of the phosphor particles, and wherein the metal oxide is coated on part of the entire surface of each coated phosphor particle. The metal oxide is coated on at least some of the phosphor particles, and wherein the metal oxide is coated on the entire surface of at least some of the coated phosphor particles. The metal oxide coated on the phosphor particles has a thickness in the range of about 10 nm to about 200 nm.

Still another aspect of the invention provides a plasma display device comprising; i) a plurality of barrier ribs configured to define a plurality of discharge cells, ii) a red phosphor layer formed in a first one of the plurality of discharge cells, iii) a green phosphor layer formed in a second one of the plurality of discharge cells and iv) a blue phosphor layer formed in a third one of the plurality of discharge cells, wherein the red, green and blue phosphor layers have the positive electrostatic polarity.

### BRIEF DESCRIPTION OF THE DRAWINGS

Embodiments of the present invention will be described with reference to the attached drawings.

FIG. 1 is a perspective view of a plasma display panel according to an embodiment of the present invention.

FIG. 2 is a sectional view of an electron emission display device according to an embodiment of the present invention.

### DETAILED DESCRIPTION OF CERTAIN INVENTIVE EMBODIMENTS

Embodiments of the present invention will now be described more fully with reference to the accompanying drawings, in which exemplary embodiments of the invention are shown.

A silicate-based blue phosphor includes Ca, Mg and Si in a host. As illustrated in Table 1 below, the silicate-based blue phosphor has a negative polarity and a negative (−) Zeta potential. On the other hand, conventional red and green phosphors have positive (+) surface charges.

TABLE 1

| | | Charge | Zeta Potential |
|---|---|---|---|
| | | (μC/g) | (mV) |
| Red | ReBO₃:Eu³⁺ where Re includes at least one rare earth | +1.2 | +40 |
| Phosphor | element selected from the group consisting of Sc, Y, La, | | |
| | Ce, and Gd | | |
| | Y₂O₃:Eu³⁺ | +1.0 | +38 |
| | Y(V,P)0₄:Eu³⁺ | +1.0 | +36 |
| Green | (Zn,A)₂SiO₄:Mn | +0.8 | +32 |
| Phosphor | where A is an alkali earth metal and can be selectively | | |
| | included | | |
| | (BaSrMg)Oₐ•Al₂O₃:Mn where 1 ≦ a ≦ 23 | +1.1 | +44 |
| | LaMgAlₓO_{y}:Tb where 1 ≦ x ≦ 14 and 8 ≦ y ≦ 47 | +1.0 | +38 |
| | ReBO₃:Tb³⁺ where Re includes at least one rare earth | +1.2 | +46 |
| | element selected from the group consisting of Sc, Y, La, | | |
| | Ce and Gd | | |
| | MgAlₓO_{y}:Mn where 1 ≦ x ≦ 10 and 1 ≦ y ≦ 30 | +1.1 | +38 |
| Blue | BaMgAlₓO_{y}:Eu²⁺ where 1 ≦ x ≦ 10 and 1 ≦ y ≦ 30 | +1.2 | +45 |
| Phosphor | CaMgSiₓO_{y}:Eu²⁺ where 1 ≦ x ≦ 10 and 1 ≦ y ≦ 30 | −0.4 | −12 |

When the silicate-based blue phosphor having a negative (−) surface charge is used in, for example, a plasma display panel (PDP), a miss discharge may occur in the PDP. Respective red, green, and blue cells of a PDP are applied with the same voltages, not with different voltages. However, as illustrated in Table 1, conventional red and green phosphors have positive (+) surface charges but the silicate-based blue phosphor has a negative (−) surface charge. Accordingly, when respective red, green, and blue cells are applied with the same voltages, a miss discharge can occur. However, when a silicate-based blue phosphor coated with metal oxide, according to an embodiment of the present invention, is used as a blue phosphor, such a miss discharge, which results from a difference in the surface charge properties of phosphors, can be prevented because the silicate-based blue phosphor has a positive (+) surface charge, that is, not a negative (−) surface charge.

In the silicate-based blue phosphor coated with metal oxide, the silicate-based blue phosphor may be represented by formula 1:

CaMgSiₓO_{y}:Eu⁺² Formula 1.

Particularly, in the silicate-based blue phosphor coated with metal oxide, the silicate-based blue phosphor can be a CaMgSi₂O₆:Eu²⁺ phosphor, but it is not limited thereto.

The silicate-based blue phosphor as a blue phosphor may be useful in a flat display device, such as a PDP or an electron emission display device, because of its constant brightness with respect to a long-time usage.

A metal oxide, which will be coated on the silicate-based blue phosphor, can be selected from metal oxides that make the surface of a silicate-based blue phosphor have a positive (+) charge. For example, the metal oxide may include at least one metal oxide selected from the group consisting of MgO, ZnO, PbO, Eu₂O₃, Nd₂O₃, Tm₂O₃, Dy₂O₃, Y₂O₃, La₂O₃, Al₂O₃, Tl₂O₃, In₂O₃, Bi₂O₂, HfO₂, CoO, CuO, NiO, Ga₂O₃, MnO₂, CeO₂, Cr₂O₃, and Sc₂O₃. However, the metal oxide is not limited to these metal oxides. For example, the metal oxide may include at least one metal oxide selected from the group consisting of MgO, La₂O₃, and Al₂O₃. They have large secondary electron emission coefficient so that brightness can be improved. In another embodiment, the metal oxide may include other chemical elements, either currently available or to be developed in the future, as long as they make the surface of a silicate-based blue phosphor have a positive (+) charge. In still another embodiment, other chemical element may be contained in or coated on at least one of the three phosphors (e.g., red, green and blue) as long as the element causes the three phosphors to demonstrate the same polarity (positive (+)).

The metal oxide may have an average diameter of about 10 nm to about 200 nm, or about 30 nm to about 170 nm. When the average diameter of the metal oxide is less than about 10 nm, the surface of the silicate-based blue phosphor may not have sufficient positive (+) polarity. On the other hand, when the average diameter of the metal oxide is greater than about 200 nm, the metal oxide may block vacuum ultraviolet rays from acting as an exciting source decreasing the amount of light emitted or light emitted from the phosphor can be blocked.

The metal oxide can be coated on the silicate-based blue phosphor in various forms. For example, the metal oxide can be partly coated on the silicate-based blue phosphor. That is, the metal oxide can be discontinuously coated on the silicate-based blue phosphor. At this time, the amount of metal oxide that is partly coated on the silicate-based blue phosphor may be in the range of about 0.01 to 5 parts by weight, or about 0.05 to about 1 part by weight, based on 100 parts by weight of the silicate-based blue phosphor. When the amount of metal oxide is less than about 0.01 parts by weight based on 100 parts by weight of the silicate-based blue phosphor, the surface of the silicate-based blue phosphor may not have a sufficient positive (+) polarity. On the other hand, when the amount of metal oxide is greater than about 5 parts by weight based on 100 parts by weight of the silicate-based blue phosphor, the metal oxide may block vacuum ultraviolet rays from acting as an exciting source decreasing the amount of light emitted or light emitted from the phosphor can be blocked.

Meanwhile, the metal oxide can be entirely coated on the silicate-based blue phosphor. That is, the metal oxide can be continuously coated on the silicate-based blue phosphor so that the metal oxide layer covers the entire surface of the silicate-based blue phosphor. At this time, the thickness of the metal oxide layer that is entirely coated on the silicate-based blue phosphor may be in the range of about 10 nm to about 200 nm, or about 30 nm to about 100 nm. When the thickness of the metal oxide is less than about 10 nm, the surface of the silicate-based blue phosphor may not have sufficient positive (+) polarity. On the other hand, when the thickness of the metal oxide is greater than about 200 nm, the metal oxide may block vacuum ultraviolet rays from acting as an exciting source in order to decrease the amount of light emitted or light emitted from the phosphor can be blocked.

The metal oxide can be coated on the silicate-based blue phosphor using various well known methods, for example, a solid phase method, a spray thermal decomposition method, a liquid phase method, a wet coating method, such as a sol-gel method, a precipitation method, or the like.

For example, the sol-gel method of coating the metal oxide on the silicate-based blue phosphor includes preparing a coating solution containing a precursor of metal oxide and a solvent, contacting the coating solution with a silicate-based blue phosphor so that the coating solution is coated on the silicate-based blue phosphor, and drying and thermally treating the coated silicate-based blue phosphor.

First, a coating solution containing a precursor of metal oxide and a solvent is prepared.

The precursor of metal oxide can be metal alkoxide or metal nitrate, such as an alkoxide or nitrate of Mg, Zn, Pb, Eu, Nd, Tm, Dy, Y, La, Al, TI, In, Bi, Hf, Co, Cu, Ni, Ga, Mn, Ce, Cr, or Sc. The solvent can be ethanol, 1-propanol, 2-propanol, methanol, and a mixture of at least two of these solvents, but the solvent is not limited thereto.

The pH of the coating solution may vary according to whether metal oxide will be partly coated on the phosphor or metal oxide will be entirely coated on the phosphor. The pH of the coating solution may be in the range of about 1.0 to about 3.0, or may be about 2.0. When the pH of the coating solution is beyond this range, a color coordinate may deteriorate.

Then, the coating solution comes into contact with the silicate-based blue phosphor so that the coating solution is coated on the silicate-based blue phosphor.

The silicate-based blue phosphor coated with the coating solution, in the cases of partial coating and entire coating, may be thermally treated at a temperature in the range of about 600° C. to about 1000° C., or may be about 800° C. When the thermal treatment temperature for the coated silicate-based blue phosphor is lower than about 600° C., the metal oxide may be ineffectively coated on the silicate-based blue phosphor. On the other hand, when the thermal treatment temperature for the coated phosphor is greater than about 1000° C., the phosphor may deteriorate, and thus the brightness of the silicate-based blue phosphor may decrease.

Meanwhile, the metal oxide can be coated on the silicate-based blue phosphor using a deposition method. The deposition method can be a plasma chemical vapor deposition (PVD) method, a chemical vapor deposition (CVD) method, a sputtering method, an electron beam evaporation method, a vacuum thermal evaporation method, a laser ablation method, a thermal evaporation method, a laser chemical vapor deposition, a jet vapor deposition method, or the like, but it is not limited thereto.

The silicate-based blue phosphor coated with metal oxide can be used in a phosphor layer included in various flat panel display devices, such as a PDP or an electron emission display device. Particularly, when the silicate-based blue phosphor coated with metal oxide is used in a PDP, a miss discharge can be prevented because the surface of the silicate-based blue phosphor coated with metal oxide has the same positive (+) polarity as the polarity of the conventional red and green phosphors. As a result, a PDP using the silicate-based blue phosphor coated with metal oxide has excellent discharge stability.

In a flat display device including a phosphor layer including the silicate-based blue phosphor coated with metal oxide, a method of forming the phosphor layer including the silicate-based blue phosphor coated with metal oxide may include preparing a phosphor paste composition that includes the silicate-based blue phosphor coated with metal oxide, a binder, and a solvent, coating the phosphor paste composition on a substrate, and thermally treating the coated phosphor paste composition.

First, a phosphor paste composition including the silicate-based blue phosphor coated with metal oxide, a binder, and a solvent is prepared. The silicate-based blue phosphor coated with metal oxide that consists of the phosphor paste composition has already been described.

In the phosphor paste composition, the binder provides a proper viscosity to the phosphor paste composition. In general, the binder is injected from the surface of a printing mask during a printing process to cover the silicate-based blue phosphor coated with metal oxide, so that a substantially uniform phosphor layer can be obtained. The binder may include at least one resin selected from the group consisting of a cellulose-based resin and an acryl-based resin. Particularly, the binder may include at least one resin selected from the group consisting of ethyl cellulose, nitro cellulose, and an acryl resin. However, the binder is not limited to these materials.

The amount of the binder may be in the range of about 5 to about 25 parts by weight, or about 7 to about 20 parts by weight, based on 100 parts by weight of the silicate-based blue phosphor coated with metal oxide. When the amount of the binder is less than about 5 parts by weight based on 100 parts by weight of the silicate-based blue phosphor coated with metal oxide, sufficient viscosity may not be obtained. On the other hand, when the amount of the binder is greater than about 25 parts by weight based on 100 parts by weight of the silicate-based blue phosphor coated with metal oxide, a carbonaceous component of the binder is insufficiently removed when the phosphor paste composition is thermally treated so that the phosphor may deteriorate.

The solvent of the phosphor paste composition provides a proper fluidity property to the phosphor paste composition, disperses the phosphor, and dissolves the binder. The solvent may include at least one material selected from the group consisting of terpineol, butyl carbitol, butyl carbitol acetate, pentenediol, dipentine, limonine, and distilled water. However, the solvent is not limited to these materials.

The amount of solvent may be in the range of about 90 to about 250 parts by weight, or about 100 to about 230 parts by weight, based on 100 parts by weight of the silicate-based blue phosphor coated with metal oxide. When the amount of solvent is less than about 90 parts by weight based on 100 parts by weight of the silicate-based blue phosphor coated with metal oxide, the dispersion property of the phosphor paste composition may decrease. On the other hand, when the amount of solvent is greater than about 250 parts by weight based on 100 parts by weight of the silicate-based blue phosphor coated with metal oxide, the viscosity of the phosphor paste composition may not be sufficient to be able to form a phosphor layer.

The phosphor paste composition may further include an antifoaming agent, a dispersing agent, a plasticizer, or the like, in addition to the silicate-based blue phosphor coated with metal oxide, the binder and the solvent. The antifoaming agent and the dispersing agent can be silicon polyester resins. The plasticizer can be a phthalate-based compound such as dioctyl phthalate 2-ethylhexyl phthalate, diisononyl phthalate, dibutyl phthalate, or diisodecyl phthalate.

The viscosity of the phosphor paste composition may be in the range of about 15000 cps to about 23000 cps, or about 17000 cps to about 21000 cps. When the viscosity of the phosphor paste composition is beyond range of about 15000 cps to about 23000 cps, the printing property of the phosphor paste composition during a coating process can decrease so that a phosphor layer having a fine pattern cannot be obtained.

Then, the phosphor paste composition prepared as described above is coated on a substrate. At this time, the “substrate” refers to a support having a region on which a phosphor layer will be formed. The substrate can be easily understood by a person having ordinary skill in the art depending on the kind of flat display device which will be formed by an individual. For example, in a case of a PDP, the substrate can be an inner surface of an emission cell of a rear panel that includes a rear substrate, an address electrode, a rear dielectric layer covering the address electrode, barrier ribs that define the emission cell, etc.

The phosphor paste composition can be coated using known various methods. For example, the phosphor paste composition can be coated using a dispenser device.

After the phosphor paste composition is coated as described above, the coated phosphor paste composition is thermally treated. When the phosphor paste composition according to an embodiment of the present invention is used, the time and temperature during the thermal treatment may vary according to materials included in the phosphor paste composition. In general, the thermal treatment may be performed at a temperature in the range of about 400° C. to about 560° C., or about 450° C. to about 510° C., for about 10 to about 45 minutes, or about 15 to about 30 minutes. When the temperature and time for the thermal treatment are less than the lower limits, the binder and the solvent may be insufficiently removed. On the other hand, when the temperature and time for the thermal treatment are greater than the upper limits, the phosphor may deteriorate.

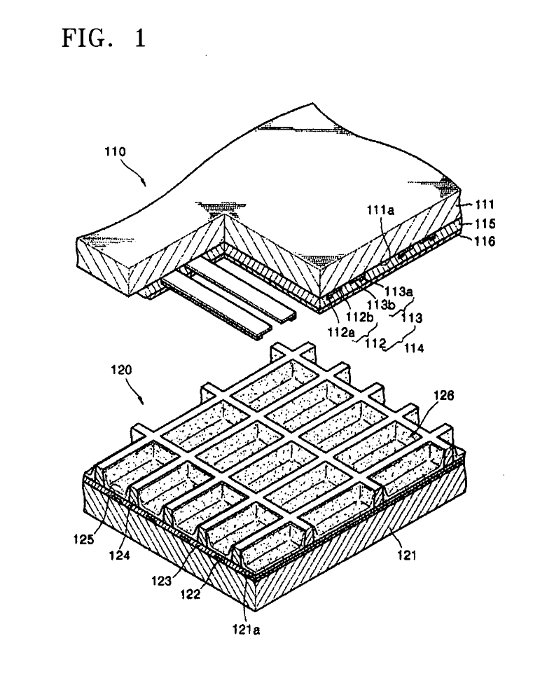

A flat display device according to an embodiment of the present invention can include the phosphor layer including the silicate-based blue phosphor coated with metal oxide formed as described above. Examples of flat display devices include a PDP, an electron emission display device, etc. FIG. 1 is a perspective view illustrating a PDP according to an embodiment of the present invention.

Referring to FIG. 1, a front panel 110 includes a front substrate 111, pairs of sustain electrodes 114 each including a Y electrode 112 and an X electrode 113 formed on a bottom surface 111a of the front substrate 111, a front dielectric layer 115 covering the sustain electrodes 114 and a protective layer 116 covering the front dielectric layer 115. The Y electrode 112 includes a transparent electrode 112b formed of indium tin oxide (ITO) and a bus electrode 112a formed of a highly conductive metal. The X electrode 113 includes a transparent electrode 113b formed of ITO and a bus electrode 113a formed of a highly conductive metal.

A rear panel 120 includes a rear substrate 12l, address electrodes 122 on a top surface 121a of the rear substrate 121 crossing the sustain electrodes 114 of the front panel 110, a rear dielectric layer 123 covering the address electrodes 122, and barrier ribs 124 defining emission cells 126 on the rear dielectric layer 123. A phosphor layer 125 including the silicate-based blue phosphor coated with metal oxide according to an embodiment of the present invention is disposed inside the emission cells 126. The silicate-based blue phosphor coated with metal oxide has a positive (+) surface charge so that when the silicate-based blue phosphor coated with metal oxide is used together with red phosphor and/or green phosphor whose surfaces have a positive (+) polarity in general, and thus a miss discharge resulting from a difference in surface charge properties of the phosphors can be prevented. As a result, the silicate-based blue phosphor coated with metal oxide can provide excellent discharge stability. The silicate-based blue phosphor coated with metal oxide has been described.

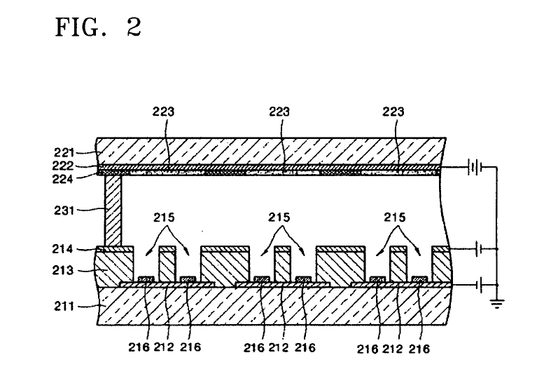

FIG. 2 is a sectional view illustrating an electron emission display device according to an embodiment of the present invention. Referring to FIG. 2, an electron emission display device has a triode structure including a cathode 212, an anode 222, and a gate electrode 214. The cathode 212 and the gate electrode 214 are formed on a rear substrate 211 on which electron emission sources 216 are disposed. The anode 222 is formed on a lower surface of a front substrate 221. A phosphor layer 223 including the silicate-based blue phosphor coated with metal oxide according to an embodiment of the present invention and a black matrix 224 improving contrast are formed on a lower surface of the anode 222. An insulating layer 213 having fine openings 215 and the gate electrode 214 are deposited on the cathode 212. The distance between the rear substrate 211 and the front substrate 221 is maintained by a spacer 231 interposed between the rear substrate 211 and the front substrate 221.

Hereinbefore, a flat display device, such as a PDP and an electron emission display device, including the phosphor layer including the silicate-based blue phosphor coated with metal oxide according to an embodiment of the present invention has been described. In another embodiment, the silicate-based blue phosphor coated with metal oxide or the phosphor layer including the silicate-based blue phosphor coated with metal oxide can be used in various other display devices, either known or to be developed in the future.

Embodiments of the present invention will be described in further detail with reference to the following examples. These examples are for illustrative purposes only and are not intended to limit the scope of the present invention.

### EXAMPLES

### Example 1

A CaMgSi₂O₆:Eu²⁺ phosphor partly coated with MgO having an average diameter of about 80 nm was prepared.

A sol-gel method was used to obtain the CaMgSi₂O₆:Eu²⁺ phosphor partly coated with MgO. First, Mg(OCH₃)₂, as a precursor of MgO, was mixed with a mixture of ethanol and 2-propanol as a solvent, thereby obtaining a coating solution. At this time, a volume ratio of the ethanol and the 2-propanol was controlled such that the pH of the coating solution was about 2.0. The coating solution came into contact with the CaMgSi₂O₆:Eu²⁺ phosphor at room temperature for about 12 hours in order to coat the coating solution on the CaMgSi₂O₆:Eu²⁺ phosphor. The CaMgSi₂O₆:Eu²⁺ phosphor that was coated with the coating solution was thermally treated at about 800° C. As a result, a CaMgSi₂O₆:Eu²⁺ phosphor partly coated with MgO in which the amount of MgO was about 0.2 parts by weight of MgO based on 100 parts by weight of a CaMgSi₂O₆:Eu²⁺ phosphor was obtained.

The charge and Zeta potential of the CaMgSi₂O₆:Eu²⁺ phosphor that was partly coated with MgO (obtained in a powder phase) were measured using a charge measuring device, such as TB-200 that is commercially available from Toshiba Chemical Co., and a Zeta master device that is commercially available from Malvern Co., respectively. As a result, the charge and Zeta potential of the CaMgSi₂O₆:Eu²⁺ phosphor that was partly coated with MgO were about 1.2 μC/g and about 44 Mv, respectively.

About 100 parts by weight of the CaMgSi₂O₆:Eu²⁺ phosphor partly coated with MgO, about 15 parts by weight of ethyl cellulose acting as a binder and about 150 parts by weight of a solvent were stirred using a paste stirrer, thereby obtaining about 1 kg of a blue phosphor paste composition having a viscosity in the range of about 19000 cps to about 21000 cps. The solvent was a mixture of terpineol and butylcarbitolacetate in a volume ratio of about 7:3.

Then, a rear substrate including address electrodes, a rear dielectric layer covering the address electrodes, and barrier ribs defining emission cells were prepared. Subsequently, the blue phosphor paste composition prepared as described above, a red phosphor paste composition including (Y,Gd)BO₃:Eu³⁺ phosphor, and a green phosphor paste composition including Zn₂SiO₄:Mn²⁺ and YBO₃:Tb³⁺ phosphor were respectively injected using a dispenser to a region in which a blue phosphor layer is to be formed, a region in which a red phosphor layer is to be formed, and a region in which a green phosphor layer is to be formed, in the emission cells. Discharge pressures of the respective phosphor paste compositions were controlled by locating each dispenser about 100 μm apart from the rear dielectric layer. Respective compositions coated in the emission cells were left to sit at about 100° C. for about 15 minutes, and then the temperature was increased by about 50° C. and each temperature raise was maintained for about 15 minutes. When the temperature reached about 500° C., the thermal treatment was performed for about 40 minutes. The thermal treatment was performed in an air atmosphere or in a nitrogen atmosphere. A panel prepared, as described above, will be referred to as Panel 1.

### Examples 2 through 22

Panels 2 through 22 were manufactured in the same manner as in Example 1, except that CaMgSi₂O₆:Eu²⁺ phosphors were partly coated with metal oxides, as illustrated in Table 2 instead of MgO. Methoxides of Zn, Pb, Eu, Nd, Tm, Dy, Y, La, Al, Tl, In, Bi, Hf, Co, Cu, Ni, Ga, Mn, Ce, Cr, and Sc are respectively used.

TABLE 2

| | | | Charge of | Zeta Potential of |
|---|---|---|---|---|
| | Metal Oxide partly | | CaMgSi₂O₆:Eu²⁺ | CaMgSi₂O₆:Eu²⁺ |
| | coated on | Average diameter | phosphor partly | phosphor partly |
| | CaMgSi₂O₆:Eu²⁺ | of metal oxide | coated with metal | coated with metal |
| Example No. | phosphor | (nm) | oxide (μC/g) | oxide (mV) |
| 1 | MgO | 80 | +1.2 | +44 |
| 2 | ZnO | 75 | +1.2 | +38 |
| 3 | PbO | 127 | +1.4 | +55 |
| 4 | Eu₂O₃ | 139 | +1.2 | +36 |
| 5 | Nd₂O₃ | 142 | +1.0 | +38 |
| 6 | Tm₂O₃ | 162 | +0.8 | +38 |
| 7 | Dy₂O₃ | 155 | +1.5 | +48 |
| 8 | Y₂O₃ | 124 | +1.4 | +50 |
| 9 | La₂O₃ | 128 | +1.6 | +55 |
| 10 | Ga₂O₃ | 96 | +1.5 | +49 |
| 11 | MnO₂ | 82 | +1.1 | +32 |
| 12 | Al₂O₃ | 52 | +1.2 | +40 |
| 13 | Tl₂O₃ | 130 | +1.0 | +36 |
| 14 | In₂O₃ | 114 | +1.2 | +48 |
| 15 | Bi₂O₃ | 106 | +1.4 | +55 |
| 16 | HfO₂ | 156 | +1.2 | +50 |
| 17 | CoO | 61 | +1.3 | +52 |
| 18 | CuO | 78 | +1.2 | +46 |
| 19 | NiO | 42 | +1.0 | +52 |
| 20 | CeO₂ | 96 | +0.8 | +40 |
| 21 | Cr₂O₃ | 63 | +1.0 | +42 |
| 22 | Sc₂O₃ | 94 | +1.0 | +44 |

### Comparative Example

A Panel A was manufactured in the same manner as in Example 1, except that the blue phosphor paste composition including CaMgSi₂O₆:Eu²⁺ phosphor was not coated with (or not containing) metal oxide but instead the CaMgSi₂O₆:Eu²⁺ phosphor is partly coated with MgO.

### Measurement Example

Discharge deviations of Panels 1 through 22 and Panel A and the brightness retention rates after 500 hours had elapsed for Panels 1 through 22 and Panel A were measured. Discharge deviations were measured according to Equation 1:

Nₜ/Nₒ=exp((−t−t_{f})/tₛ) <Equation 1>

where Nₜ denotes the number of miss discharges for t hours, Nₒ denotes the number of discharge delay times, t_{f} denotes a formation delay time, and tₛ denotes a discharge deviation.

Initial brightness of the respective panels were measured using a Kr-lamp spectrometer in a Darsa system including a vacuum chamber of 10⁻⁵ torr. After 500 hours, the brightness of the respective panels were measured in the same manner that the initial brightness of the respective panels were measured. A brightness retention rate is a percentage of brightness after 500 hours with respect to initial brightness.

Discharge deviations of Panels 1 through 22 and Panel A and the luminosity retention rates after 500 hours of Panels 1 through 22 and Panel A were measured as described above and are illustrated in Table 3:

TABLE 3

| | Metal oxide coated on | Discharge | Brightness retention |
|---|---|---|---|
| Example | CaMgSi₂O₆:Eu²⁺ | Deviation | rate after 500 hours |
| No. | phosphor | (nsec) | (%) |
| A | — | 592 | 85 |
| 1 | MgO | 42 | 92 |
| 2 | ZnO | 43 | 93 |
| 3 | PbO | 47 | 92 |
| 4 | Eu₂O₃ | 50 | 92 |
| 5 | Nd₂O₃ | 53 | 90 |
| 6 | Tm₂O₃ | 49 | 90 |
| 7 | Dy₂O₃ | 45 | 92 |
| 8 | Y₂O₃ | 43 | 93 |
| 9 | La₂O₃ | 42 | 92 |
| 10 | Ga₂O₃ | 49 | 90 |
| 11 | MnO₂ | 48 | 90 |
| 12 | Al₂O₃ | 42 | 93 |
| 13 | Tl₂O₃ | 50 | 92 |
| 14 | In₂O₃ | 52 | 91 |
| 15 | Bi₂O₃ | 56 | 91 |
| 16 | HfO₂ | 55 | 93 |
| 17 | CoO | 55 | 92 |
| 18 | CuO | 53 | 90 |
| 19 | NiO | 53 | 90 |
| 20 | CeO₂ | 60 | 91 |
| 21 | Cr₂O₃ | 47 | 90 |
| 22 | Sc₂O₃ | 76 | 91 |

As illustrated in Table 3, the discharge deviation of Panel A including a phosphor layer including CaMgSi₂O₆:Eu²⁺ phosphor that was not coated with metal oxide was as much as about 592 nsec. That is, Panel A showed poor discharge stability. The brightness retention rate after 500 hours of Panel A was as low as about 85%. On the other hand, among the discharge deviations of Panels 1 through 22 including phosphor layers including CaMgSi₂O₆:Eu²⁺ phosphor coated with metal oxide, the maximum discharge deviation was as short as about 68 nsec. That is, Panels 1 through 22 showed excellent discharge stability. The brightness retention rates after 500 hours of Panels 1 through 22 were about 90% or higher. That is, even when Panels 1 through 22 were used for a long time, their luminosities do not deteriorate.

A silicate-based blue phosphor coated with metal oxide according to at least one embodiment of the present invention has a positive (+) surface charge. Accordingly, when it is used together with red phosphor and/or green phosphor whose surfaces demonstrate a positive (+) polarity in general, excellent discharge stability and a high brightness retention rate can be obtained. A flat display device, such as a PDP or an electron emission display device, including the silicate-based blue phosphor coated with metal oxide has improved reliability.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A phosphor composition comprising a silicate-based phosphor and metal oxide.

2. The phosphor composition of claim 1, wherein the silicate-based phosphor is a blue phosphor.

3. The phosphor composition of claim 1, wherein the silicate-based blue phosphor has a positive electrostatic polarity.

4. The phosphor composition of claim 1, wherein at least part of the silicate-based phosphor is in the form of particles, and wherein the metal oxide is formed on a surface of the phosphor particles.

5. The phosphor composition of claim 1, wherein the silicate-based phosphor is represented by Formula 1:
CaMgSiₓO_{y}: Eu⁺². Formula 1

6. The phosphor composition of claim 1, wherein the silicate-based phosphor comprises a CaMgSi₂O₆:Eu²⁺ phosphor.

7. The phosphor composition of claim 1, wherein the metal oxide comprises at least one oxide selected from the group consisting of MgO, ZnO, PbO, Eu₂O₃, Nd₂O₃, Tm₂O₃, Dy₂O₃, Y₂O₃, La₂O₃, Al₂O₃, Tl₂O₃, In₂O₃, Bi₂O₃, HfO₂, CoO, CuO, NiO, Ga₂O₃, MnO₂, CeO₂, Cr₂O₃, and Sc₂O₃.

8. The phosphor composition of claim 1, wherein the metal oxide comprises at least one oxide selected from the group consisting of MgO, La₂O₃, and Al₂O₃.

9. The phosphor composition of claim 1, wherein the metal oxide is in the form of particles, and wherein the metal oxide particles have an average diameter in the range of about 10 nm to about 200 nm.

10. The phosphor composition of claim 4, wherein the metal oxide is coated on at least some of the phosphor particles, and wherein the metal oxide is coated on part of the entire surface of each coated phosphor particle.

11. The phosphor composition of claim 1, wherein the amount of the metal oxide is in the range of about 0.01 to about 5 parts by weight based on 100 parts by weight of the silicate-based phosphor.

12. The phosphor composition of claim 4, wherein the metal oxide is coated on at least some of the phosphor particles, and wherein the metal oxide is coated on the entire surface of at least some of the coated phosphor particles.

13. The phosphor composition of claim 10, wherein the metal oxide coated on the phosphor particles has a thickness in the range of about 10 nm to about 200 nm.

14. The phosphor composition of claim 1, further comprising a binder and a solvent.

15. The phosphor composition of claim 14, wherein the binder comprises at least one material selected from the group consisting of ethyl cellulose, nitro cellulose, and an acrylic resin.

16. The phosphor composition of claim 14, wherein the solvent comprises at least one material selected from the group consisting of terpineol, butyl carbitol, butyl carbitol acetate, pentenediol, dipentine, limonine, and water.

17. A flat display device comprising a phosphor layer, wherein the phosphor layer comprises the silicate-based blue phosphor of claim 2.

18. The flat display device of claim 17, wherein the flat display device is a plasma display or an electron emission display device.

19. The flat display device of claim 17, wherein the silicate-based blue phosphor has a positive electrostatic polarity.

20. A plasma display device comprising;
a plurality of barrier ribs configured to define a plurality of discharge cells;
a red phosphor layer formed in a first one of the plurality of discharge cells;
a green phosphor layer formed in a second one of the plurality of discharge cells; and
a blue phosphor layer formed in a third one of the plurality of discharge cells, wherein the red, green and blue phosphor layers have the positive electrostatic polarity.

21. The device of claim 20, wherein the blue phosphor layer comprises a material represented by Formula 1:
CaMgSiₓO_{y}: Eu⁺². Formula 1

22. The device of claim 20, wherein the blue phosphor layer comprises at least one metal oxide selected from the group consisting of MgO, ZnO, PbO, Eu₂O₃, Nd₂O₃, Tm₂O₃, Dy₂O₃, Y₂O₃, La₂O₃, Al₂O₃, Tl₂O₃, In₂O₃, Bi₂O₃, HfO₂, CoO, CuO, NiO, Ga₂O₃, MnO₂, CeO₂, Cr₂O₃, and Sc₂O₃.
